(19) United States
(12) Patent Application Publication
(10) Pub. No.: US 2011/0272256 A1
(43) Pub. Date: Nov. 10, 2011

(54) ANTI IDLING CHANNEL AND CORNER BLOCK MECHANISM AND METHOD OF INSTALLATION

(75) Inventors: LeRoy T. WARREN, JR., Richmond, VA (US); Charles A. LEE, Williamsburg, VA (US)

(73) Assignee: QUBICAAMF WORLDWIDE LLC, Mechanicsville, VA (US)

(21) Appl. No.: 13/101,697

(22) Filed: May 5, 2011

Related U.S. Application Data
(60) Provisional application No. 61/332,523, filed on May 7, 2010.

(51) Int. Cl. B65G 15/60; B23P 23/00

(52) U.S. Cl. 198/841; 29/401.1

(57) ABSTRACT

Components (anti-idling system) for use with a pinspotter system and method of installation is described herein. The anti-idling system includes an anti-idling channel provided underneath a pit conveyor belt adjacent a rear roller of the pit conveyor belt and an elevator system of a pinspotter assembly. The anti-idling channel has a fastening mechanism structured to attach the anti-idling channel to a sidewall of the pinspotter assembly.

### CROSS REFERENCE TO RELATED APPLICATIONS

The present application is a non-provisional application of U.S. Provisional Application Ser. No. 61/332,523, filed on May 7, 2010, the contents of which are incorporated by reference in its entirety herein.

### BACKGROUND OF THE INVENTION

1. Field of the Invention

The present invention relates to a bowling apparatus and, more particularly, to components for use with a pinspotter system and method of installation.

2. Description of Background

A pinspotter system is a mechanism that automatically sets up and spots bowling pins on a bowling alley lane, amongst other features. More specifically, a pinspotter system is a machine whose function is to automate the sport of bowling by setting bowling pins on the bowling lane surface and returning bowling balls to a bowler. An objective of the pinspotter system is to provide bowling pins to the pin deck as rapidly as possible so that a game of bowling can be played swiftly without undue delays. It is thus important that any mechanisms of the pinspotter system minimize the likelihood of jams, misplaced pins or other failures which would take a bowling alley lane out of service and/or cause and unacceptable delay in a game of bowling.

To accomplish the functions of the pinspotter system many mechanical and electrical components, including controllers, are required. For example, the mechanical components of a pinspotter system include a cushion, which stops the ball and deflects it to the pit area to be returned to the bowler. Additional components include the sweep that is designed to remove fallen pins from the pin deck and adjacent gutters. A pit conveyor belt carries the fallen pins to the pin elevator, where they are can-led up to a distributor assembly. The distributor assembly then distributes the pins to a pin table which, in turn, sets on the bowling pins on the bowling alley surface. However, the bowling pins can become stuck at certain portions on the belt thus requiring human intervention to remove such bowling pins. This results in a delay of the game, in addition to added expense.

Accordingly, there exists a need in the art to overcome the deficiencies and limitations described hereinabove.

### SUMMARY

In an aspect of the invention, an anti-idling system comprises an anti-idling channel provided underneath a pit conveyor belt adjacent a rear roller of the pit conveyor belt and an elevator system of a pinspotter assembly. The anti-idling channel includes a fastening mechanism structured to attach the anti-idling channel to a sidewall of the pinspotter assembly.

In another aspect of the invention, a kit comprises components for preventing idling of a bowling pin on a pit conveyor belt. The components comprise an anti-idling channel. The anti-idling channel has a fastening mechanism structured to attach the anti-idling channel to a sidewall of a pinspotter assembly. The components further comprise an anti-idling corner block. The anti-idling corner block has a fastening mechanism structured to attach the anti-idling corner block to a corner of the pinspotter assembly.

In yet another aspect of the invention, a method of installing an anti-idling system, comprises: removing a pit conveyor belt from an existing pinspotter system and, if necessary, other components necessary to gain access to underneath the pit conveyor belt; attaching an anti-idling channel to a sidewall of the existing pinspotter system on at least a first side, and underneath a surface of the pit conveyor belt such that when reinstalled, the pit conveyor belt is devoid of a depression near an entrance to an elevator system; and reassembling the pit conveyor belt and, if removed, the other components that were necessary to gain access to underneath the pit conveyor belt.

### BRIEF DESCRIPTION OF THE DRAWINGS

The present invention is described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a conventional system having an unsupported pit conveyor belt;

FIG. 2 shows an anti-idling channel system in accordance with aspects of the present invention;

FIG. 3 shows an anti-idling channel system and anti-idling corner block in accordance with aspects of the invention;

FIG. 4 shows an exploded view of the anti-idling channel system and anti-idling corner block in accordance with aspects of the invention; and

FIG. 5 shows an environment in which the present invention is implemented, in accordance with aspects of the present invention.

### DESCRIPTION

The present invention relates to a bowling apparatus and, more particularly, to components for use with a pinspotter system and method of installation. In particular, the present invention relates to an anti-idling system used with a pinspotter system and ball return mechanism. In embodiments, the anti-idling system of the present invention prevents idling of bowling pins in the pit area of a bowling alley lane and, more specifically, ensures that bowling pins will be properly guided into the pin elevator assembly of the pinspotter system. This is accomplished by, for example, eliminating sag in the pit conveyor belt (e.g., carpet), adjacent a pin elevator assembly of the pinspotter system. In this way, the anti-idling system of the present invention prevents the bowling pin from sitting in a depression of the pit conveyor belt, which would otherwise prevent the bowling pin from entering the pin elevator assembly of the pinspotter system.

In embodiments, the anti-idling system of the present invention includes an anti-idling channel for supporting the pit conveyor belt. In embodiments, the anti-idling channel will support the conveyor belt in an area between a bounce plate and rear roller of the pinspotter system. In this location, for example, the anti-idling channel will prevent a bowling pin from “idling” in front of the pin elevator assembly, e.g., prevent endlessly rolling on the conveyor belt without entering the pin elevator assembly. In embodiments, the anti-idling system also includes an anti-idling corner block for guiding the head of a bowling pin such that the bowling pin rolls forward, away from the pin elevator assembly and turns around, consequently entering the pin elevator assembly in a correct orientation. That is, the anti-idling corner block will prevent the bowling pin from being oriented in a position that would result in “idling” in front of the pin elevator assembly.

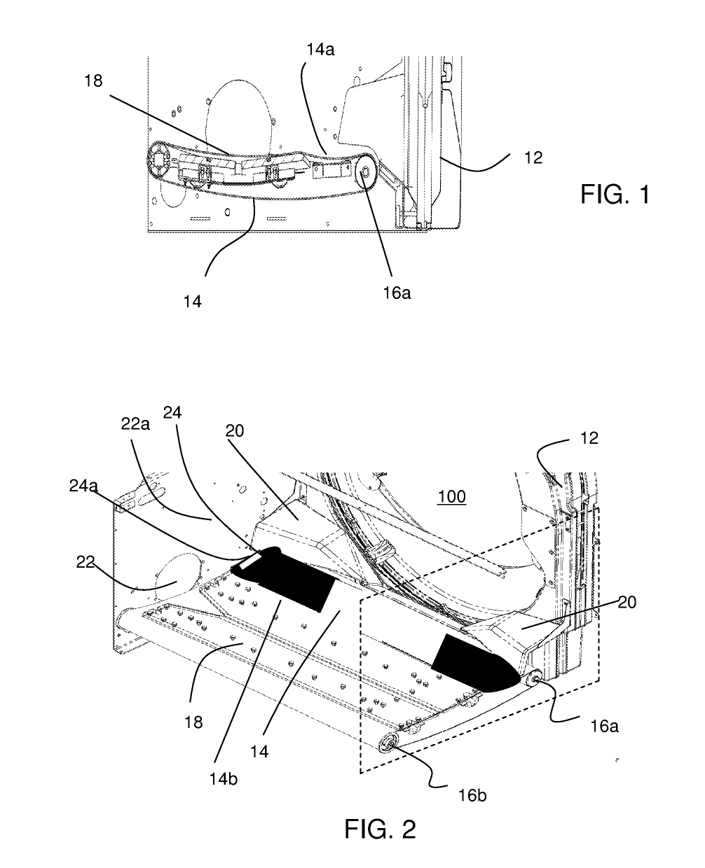

FIG. 1 shows a conventional system having an unsupported pit conveyor belt. More specifically, in conventional systems, a portion 14a of a pit conveyor belt 14 between a bounce board assembly 18 and a rear roller 16a is unsupported, e.g., a portion of approximately 6″ wide. In this area, the pliable pit conveyor belt 14 can sag, causing a bowling pin to sit in this depression, resulting in an “idled” bowling ball, i.e., preventing the bowling ball from entering a pin elevator assembly 12. This is not desirous because a bowling pin remaining on the pit conveyor belt 14 would not be available to the pinspotter system, e.g., pin elevator assembly 12, for setting the bowling pin on the bowling alley lane surface. To correct this situation requires human intervention.

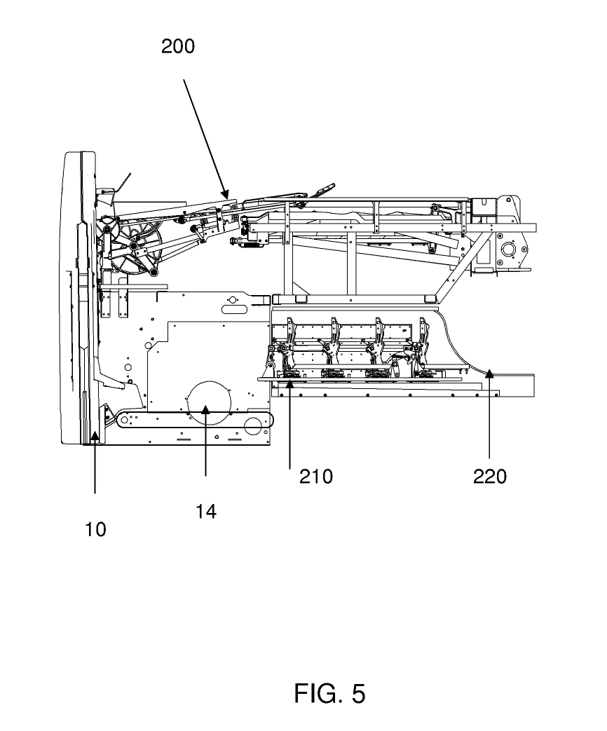

FIG. 2 shows an anti-idling channel system in accordance with embodiments of the invention. More specifically, FIG. 1 shows a cutaway portion of a pinspotter and pin elevator assembly, generally depicted as reference numeral 10. The pinspotter and pin elevator assembly 10 includes a pin elevator assembly 12, which receives bowling pins from a pit conveyor belt 14 positioned in front of the pin elevator assembly 12. A pair of plows 20 are provided in front of the pin elevator assembly 12, and partly over the pit conveyor belt 14. In embodiments, the plows 20 are structured and designed to properly orient the bowling pins and then direct them into the pin elevator assembly 12, which is configured to bring the bowling pins from the pit conveyor belt 14 to a distributor assembly (see, e.g., FIG. 5 reference numeral 200). The distributor assembly 200 then distributes the bowling pins to a pin table (see, e.g., FIG. 5 reference numeral 210) which, in turn, sets the bowling pins 215 on the bowling alley surface (see, e.g., FIG. 5 reference numeral 220).

As further shown in FIG. 2, the pit conveyor belt 14 is operated (e.g., moved) by one or two rollers, i.e., a rear roller 16a and a front roller 16b. The rollers 16a, 16b may be powered by an electric motor, for example. A portion 14b of the pit conveyor belt 14 between the rear roller 16a and the front roller 16b is supported on its underside by a bounce board assembly 18. In embodiments, the bounce board assembly 18 is positioned on a side of a bowling ball return opening 22. In embodiments, the bounce board assembly 18 can support the bowling pins and the bowling ball. In further embodiments, the bounce board assembly 18 may be provided at a slight slope towards a bowling ball return opening 22 in a sidewall 22a, so that a bowling ball can be directed towards and then through the bowling ball return opening 22, to a ball return mechanism.

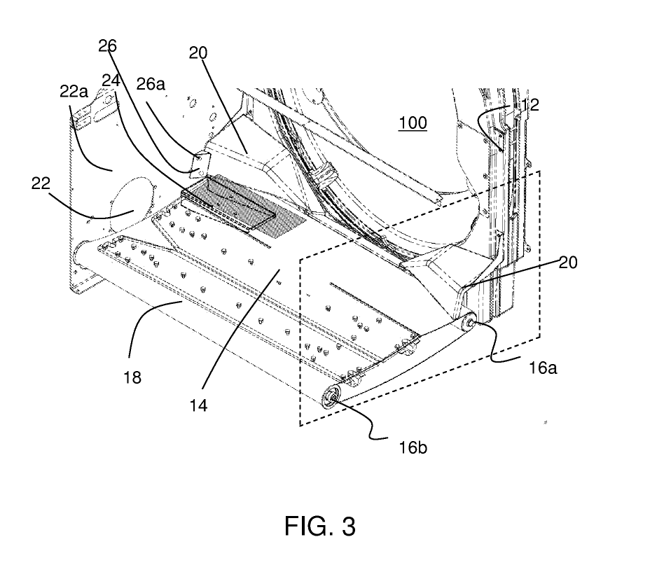

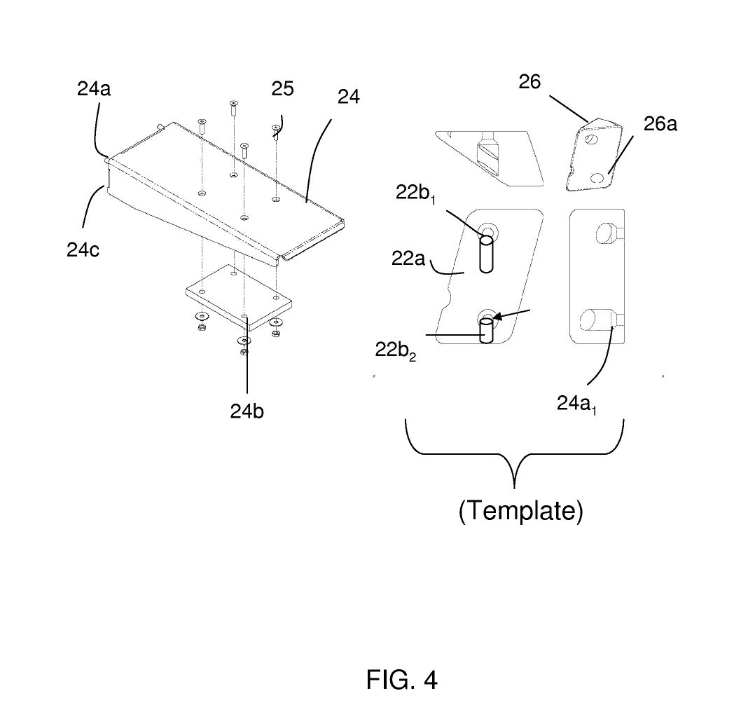

As further shown in FIG. 2, the present invention solves the above noted problem of FIG. 1, by use of an anti-idling channel 24 (see also, e.g., FIGS. 3 and 4). The anti-idling channel 24 is designed and structured to support the pit conveyor belt 14 between the bounce board assembly 18 and the rear roller 16a (or plows 20), thus eliminating belt sag, i.e., the depression in the conveyor belt in section 14a. In embodiments, the anti-idling channel 24 can be positioned at a slight slope towards an opening 100 of the pin elevator assembly 12. This slight slope can be, for example, at an angle of between 1° and 5°, and the length can range from about four to about 18 inches; although other dimensions are also contemplated by the present invention. For example, in embodiments, the anti-idling channel 24 can extend the full length of the plow 20, or substantially the full length of the plow 20. The width anti-idling channel 24 should be about six; although other dimensions between the bounce board assembly 18 and the rear roller 16a (or plows 20) are contemplated by the present invention. In any scenario, the anti-idling channel 24 will be positioned directly in front of the plow 20 and under the pit conveyor belt 14, directing the bowling pins into the opening 100 of the pin elevator 12.

In embodiments, the anti-idling channel 24 can be attached to the sidewall 22a on either or both sides of the pin elevator assembly 12. In embodiments, the anti-idling channel 24 can be attached by bolts, screws, brackets, mounting studs or other fastening devices, generally depicted at reference numeral 24a. (See, also FIG. 4). In one illustrative example, the brackets 24a can be angle brackets attached to the sidewalls 22a. In embodiments, the anti-idling channel 24 can be located on either or both sides of the pin elevator assembly 12. The anti-idling channel 24 can also include a dampening pad 24b, mounted to an underside of the anti-idling channel 24 (See, FIG. 4). The dampening pad 24b will dampen or lessen any vibrations resulting from bowling pin chatter.

In embodiments, the anti-idling channel 24 can be made from metallic or non-metallic materials such as thermoplastics or other plastic materials. In embodiments, for example, the anti-idling channel 24 can be made from thermoformed thermo-plastic-olefin (TPO) and/or injected molded impact modified polymer plastic components. The dampening pad 24b can be made from, for example, a rubber or plastic type material.

FIG. 3 shows an exploded view of an anti-idling channel and anti-idling corner block in accordance with aspects of the invention. In the embodiment of FIG. 3, an anti-idling corner block 26 prevents bowling pins from remaining on a portion of the pit conveyor belt 14. For example, working in conjunction with the anti-idling channel 24, the anti-idling corner block 26 causes a bowling pin that would otherwise “idle”, or remain on the pit conveyor belt 14, to roll in such a way that it turns around perpendicular to the direction of travel of the pit conveyor belt 14, consequently entering the pin elevator assembly 12 (e.g., opening 100 of the pin elevator assembly). More specifically, the anti-idling corner block 26 guides the head of a bowling pin such that the bowling pin rolls forward, away from the pin elevator assembly 12 and turns around, consequently entering the pin elevator assembly 12 in a correct orientation. In this way, the anti-idling corner block 26 will prevent the bowling pin from being oriented in a position that would result in “idling” in front of the pin elevator assembly 12.

In embodiments, the anti-idling corner block 26 is wedge shaped, and can be mounted adjacent to one or both of the plows 20, at a corner location, for example. In further embodiments, the anti-idling corner block 26 can be mounted above the pit conveyor belt 14, adjacent to the anti-idling channel 24. The anti-idling corner block 26 can include mounting studs or bolt holes 26a, for mounting onto the sidewall 22a of the pinspotter system 10, for example. The anti-idling corner block 26 can be made from metallic or non-metallic materials such as thermoplastics or other plastic materials. In one embodiment, the anti-idling corner block 26 can be made from thermoformed thermo-plastic-olefin (TPO) and/or injected molded impact modified polymer plastic components.

FIG. 4 shows an exploded view of the anti-idling channel system and anti-idling corner block in accordance with aspects of the invention. As shown in FIG. 4, the anti-idling channel 24 can be wedge shaped, with a flat surface. As a mounting mechanism, the anti-idling channel 24 can include, in embodiments, mounting studs 24a which engage holes 22b of the sidewalls 22a of the pinspotter system. In embodiments, the mounting studs 24a have a larger diameter end portion 24a₁, which can be fitted into a larger diameter portion 22b₁ of the engaging holes 22b. Once the larger diameter end portion 24a₁ is fitted into the larger diameter portion 22b₁ of the engaging holes 22b, the anti-idling channel 24 can be slid downwards into a slotted portion 22b₂ of the engaging holes 22b. In this way, the anti-idling channel 24 will be locked into the engage holes 22b of the sidewalls 22a of the pinspotter system. By using this configuration (structure), the use of the mounting studs 24a can eliminate the need for mounting bolts or other fasteners, thereby facilitating easy installation and removal of the anti-idling channel 24. That is, installation and removal of the anti-idling channel 24 can be accomplished by simply sliding the mounting studs 24a from the engaging holes 22b. Also, due to the wedge or other shape of the anti-idling channel 24, the mounting studs 24a in combination with an end surface 24c of the anti-idling channel 24 can support the pit conveyor belt 14 and any bowling pins thereon.

As further shown in FIG. 4, the dampening pad 24b can be affixed to an underside of the anti-idling channel 24. More specifically, the dampening pad 24b can be affixed to the anti-idling channel 24 by a plurality of bolts or rivets 25. In embodiments, the dampening pad 24b can be rectangular in shape; although other dimensions are also contemplated by the present invention. Moreover, in embodiments, the dampening pad 24b can be flat or substantially flat, with at least one surface contacting an underside of the anti-idling channel 24.

Still referring to FIG. 4, the anti-idling corner block 26 is shown to be a wedge shape. This shape facilitates the placement of the anti-idling corner block 26 in the corner of a pinspotter system. In embodiments, the anti-idling corner block 26 can include bolt holes 26a for use with bolts. The bolts can be used to attach the anti-idling corner block 26 to a corner of the pinspotter system, preferably adjacent to the plows.

As should be understood by those of ordinary skill in the art, the anti-idling channel 24 and the anti-idling corner block 26 (and related components) can be retrofitted onto existing pinspotter systems such as, for example, QubicaAMF pinspotter models from 82-70 through current 90XLi series; although, other models are also contemplated by the present invention. In further embodiments, the anti-idling channel 24 and the anti-idling corner block 26 (and related components) can be provided as a kit for the installation in any pinspotter assemblies such as, for example, shown in FIG. 5. To this end, the anti-idling channel 24 and the anti-idling corner block 26 can be sold/used for new pinspotter systems, and also be available as an upgrade to existing pinspotter systems, in order to significantly eliminate idle bowling pins on the conveyor.

In providing the anti-idling channel 24 and the anti-idling corner block 26 to customers, installation instructions can be provided. The instructions can include, for example, a template for aligning and drilling holes in appropriate locations. The template can be, for example, represented in FIG. 4. More specifically, the method of installation can include, for example, the following instructions:

1. Remove the pit conveyor belt from an existing pinspotter system and, if necessary, plows and/or other components necessary to gain access to underneath the pit conveyor belt;

2. If no holes are provided in a sidewall of the existing pinspotter system, then measure and drill holes underneath a surface of the pit conveyor belt by aligning with a template. If no template is provided, then the holes can be aligned with the bolt or screw holes, mounting studs or other fastening devices of the anti-idling channel;

3. As an optional step prior to installation of the anti-idling channel, attach the dampening pad to an underside of the anti-idling channel. This can be accomplished by bolting the dampening pad to the underside of the anti-idling channel (as shown in FIG. 4);

4. Attach the anti-idling channel to the sidewall of the existing pinspotter system;

5. Repeat steps 1-4 for the other side of the pinspotter system;

6. Reassemble the pit conveyor belt and, if necessary, plows and/or other components that were necessary to gain access to underneath the pit conveyor belt;

7. For the anti-idling corner block, if no holes are provided in a sidewall of the existing pinspotter system, then measure and drill holes using either a template (FIG. 4) or aligning the anti-idling corner block in a corner of the pinspotter system, above the pit conveyor belt; and

8. Attach the anti-idling corner block to the sidewall of the existing pinspotter system.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An anti-idling system comprising an anti-idling channel provided underneath a pit conveyor belt adjacent a rear roller of the pit conveyor belt and an elevator system of a pinspotter assembly, the anti-idling channel having a fastening mechanism structured to attach the anti-idling channel to a sidewall of the pinspotter assembly.

2. The system of claim 1, wherein the anti-idling channel comprises a flat top surface.

3. The system of claim 2, wherein the anti-idling channel is tapered.

4. The system of claim 1, wherein the fastening mechanism includes a stud having a large diameter portion and small diameter portion, the large diameter portion is remote from an end of the anti-idling channel and the small diameter portion is closer to the end.

5. The system of claim 1, wherein the anti-idling channel is positioned between a bounce plate under the pit conveyor belt and the rear roller of the pit conveyor belt.

6. The system of claim 1, further comprising a dampening plate provided on an underside of the anti-idling channel.

7. The system of claim 1, wherein the anti-idling channel is made from metallic materials.

8. The system of claim 1, wherein the anti-idling channel is made from at least one of thermoformed thermo-plastic-olefin (TPO) and injected molded impact modified polymer plastic components.

9. The system of claim 1, further comprising an anti-idling corner block positioned adjacent to the anti-idling channel, above the pit conveyor belt, wherein the anti-idling corner block is wedge shaped, and which further comprises a fastening device.

10. A kit comprising components for preventing idling of a bowling pin on a pit conveyor belt, the components comprising:
an anti-idling channel, the anti-idling channel having a fastening mechanism structured to attach the anti-idling channel to a sidewall of a pinspotter assembly; and
an anti-idling corner block, the anti-idling corner block having a fastening mechanism structured to attach the anti-idling corner block to a corner of the pinspotter assembly.

11. The kit of claim 10, further comprising a dampening plate structure to attach to an underside of the anti-idling channel.

12. The kit of claim 10, wherein the anti-idling channel comprises flat top surface and a tapered shape.

13. The kit of claim 12, wherein the fastening mechanism for the anti-idling channel includes at least one stud having a large diameter portion and small diameter portion, wherein the large diameter portion is remote from an end of the tapered shaped anti-idling channel and the small diameter portion is closer to the end.

14. The kit of claim 10, wherein the anti-idling channel is made from at least one of thermoformed thermo-plastic-olefin (TPO) and injected molded impact modified polymer plastic components.

15. The kit of claim 10, wherein the anti-idling corner block is wedge shaped.

16. The kit of claim 10, further comprising at least one template structured for aligning holes in a sidewall of the pinspotter assembly with the fastening mechanism of at least of the anti-idling channel and the anti-idling corner block.

17. A method of installing an anti-idling system, comprising:
removing a pit conveyor belt from an existing pinspotter system and, if necessary, other components necessary to gain access to underneath the pit conveyor belt;
attaching an anti-idling channel to a sidewall of the existing pinspotter system on at least a first side, and underneath a surface of the pit conveyor belt such that when reinstalled, the pit conveyor belt is devoid of a depression near an entrance to an elevator system; and
reassembling the pit conveyor belt and, if removed, the other components that were necessary to gain access to underneath the pit conveyor belt.

18. The method of installing of claim 17, comprising drilling holes in the sidewall of the existing pinspotter system prior to the attaching of the anti-idling channel.

19. The method of installing of claim 17, further comprising attaching an anti-idling corner block to a corner of the existing pinspotter system, adjacent to an entrance of a pin elevator system.

20. The method of installing of claim 17, further comprising attaching a dampening pad to an underside of the anti-idling channel.
